(19) United States
(12) Patent Application Publication
(10) Pub. No.: US 2010/0323890 A1
(43) Pub. Date: Dec. 23, 2010

(54) METHOD FOR IMPROVING THE RESISTANCE OF PLANTS TO STRESS AND CORRESPONDING PRODUCTS

(76) Inventors: Abdelhak El Amrani, Rennes (FR); Francisco Cabello, Rennes (FR); Christophe Biteau, Vitre (FR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/675,841

(22) PCT Filed: Sep. 4, 2008
(86) PCT No.: PCT/EP2008/061676

§ 371 Date: Sep. 9, 2010

(30) Foreign Application Priority Data
Sep. 6, 2007 (FR) 0757372

(51) Int. Cl. A01N 25/32; A01N 43/16; A01P 21/00

(52) U.S. Cl. 504/108; 504/292

(57) ABSTRACT

The invention relates to a method for improving the resistance of plants to at least one type of stress. According to the invention, the method is characterised in that it comprises at least one step of cultivating at least one plant in the presence of at least one water-soluble exogenous carbohydrate that can be assimilated by the plant and in the presence of at least one molecule of the polyamine family or a substance containing said molecule of the polyamine family.

### FIELD OF THE INVENTION

The invention relates to the field of the resistance of plants to natural, biotic or abiotic, or artificial environmental stress.

More specifically, the invention relates to a method for improving the growth of the aerial part and the roots and/or the photosynthetic activity of plants liable to be subject to such stress. The various forms of stress concerned include, but are not restricted to: (i) abiotic natural stress due to drought, temperature, salt content of soils, ultraviolet radiations, hypoxia and/or anoxia, excessive moisture, mineral or organic nutrient deficiencies, (ii) biotic stress due to bacterial, viral, parasitic pathogen infections or harmful organisms (insects, nematodes, etc.), (iii) stress generated by industrial or agricultural xenobiotic pollution.

The invention will particularly, but not exclusively, find an application in the improvement of so-called phytoremediation methods intended to decontaminate soils polluted by various types of atmospheric or non-atmospheric, organic or heavy metal pollutants, consisting of cultivating, on the soils in question, plants fixing or degrading all or part of said pollutants.

The endogenous production of reactive and unstable oxygenated species, such as ozone (O₃), the superoxide anion (O₂⁻), singlet oxygen, hydrogen peroxide (H₂O₂), the hydroxyl radical (OH⁻), nitrogen oxides (NO) and/or peroxynitrite (NO₃⁻), etc. is an unavoidable process in aerobic life. The cell metabolism is protected by various defense systems involving antioxidant molecules (ascorbic acid, tocophenol, glutathione, caratenoids, etc.), enzymes (superoxide dismutase, catalase, peroxidases, etc.) and/or essential trace elements for enzyme activities (copper, zinc, selenium). Some of these oxygen-reactive species are known as “endogenous mediators” of vital biological functions in plant cells (cell growth, photosynthesis, apoptosis, etc.). However, any cellular disturbance leading to excess production of these compounds results in toxic endogenous oxidative stress inducing irreversible lesions on all types of macromolecules (proteins due to denaturing, lipids due to peroxidation, nucleic acids due to ruptures or mutations, carbohydrates due to oxidation and other chloroplast molecules) liable to prove to be detrimental or fatal for the plant.

Oxidative stress is a non-specific phenomenon, the cellular result of numerous forms of non-oxidative environmental stress external to the cell, such as the cold, drought, salinity, in particular.

The cold reduces the fluidity of lipid membranes which impedes plastoquinone mobility and the reactivity of the enzymes involved in the dark phase of photosynthesis. This results in an increase in the endogenous concentration of oxygenated reactive species and an imbalance with antioxidant defense systems.

Increasing the resistance of some plants to the cold would make it possible to cultivate same at northern latitudes and feed some populations better particularly by diversifying their food.

Drought induces the closure of plant stomata which decreases the CO₂ concentration and thus the photosynthetic yield. Hydric stress and osmotic stress are particularly studied due to the impacts thereof on plants of agricultural value. These forms of stress are increasingly frequent and the significance thereof increases as the world's population grows. In this way, at the present time, only 20% of the millions of square kilometers of the globe are suitable for cultivation and this surface area decreases significantly each year particularly due to the development of intensive farming and global warming.

Therefore, increasing the resistance of plants to the environmental stress represented by drought and soil salinity could enable the cultivation thereof in regions of the globe subject to potential temperature elevation, and thus to drying and salinization of soils. The effect of global warming on agriculture would thus be reduced extensively.

### PRIOR ART

The strategies for improving the resistance of plants to stress based either on conventional plant improvement techniques using crossing or on more recent genetic engineering techniques have the drawback of being specific for the plant and stress. Moreover, they pose difficult scientific problems, which have not been fully elucidated to date. The development and implementation thereof require time, qualified personnel and are thus very costly. Very few field trials have been conducted to date, particularly in the case of trials on transgenic plants.

Furthermore, genetic engineering techniques particularly consisting of inserting genes of bacteria or halophilous model plants in the genome of some cultivated species (tomatoes, rice, wheat, etc.) involve the use of GMOs which have not been accepted on a societal level to date.

The present invention which is non-specific for the plant/stress pair offers the advantages of being applicable to various plants subject to various types of environmental stress. It involves the use of compounds which are non-toxic for the environment, biodegradable, readily commercially available at a low cost and in large quantities. The method makes it possible to increase the physiological defense mechanisms against environmental stress and is easy to implement on a large scale and economically advantageous.

In particular, the invention will prove to be particularly useful for the restoration of soils contaminated by pesticides which induce oxidative stress and inhibit photosynthesis, such as triazines in particular.

Triazines are heterocycles comprising three nitrogen atoms, some of which are used as herbicides (atrazine, simazine and terbuthylazine), particularly in corn crops. These compounds represent a major source of pollution on a global scale. For example, in France, even though the use thereof has been prohibited since Jun. 30, 2003, following decades of use, these products and the degradation products thereof are detected in the environment (soils, waterways, groundwater tables, drinking water reserves, etc.) at levels up to ten times higher than the previously authorized limit (0.1 mg/l). Some product storage, production or accidental dispersal sites are particularly polluted. The use thereof is not prohibited everywhere since atrazine is still widely used particularly in the United States and in developing countries.

Atrazine (2-chloro-4-ethylamino-6-isopropylamine-1,3,5-triazine) is a molecule which inhibits photosynthesis (more specifically photosystem II), i.e. the conversion of light energy into electrochemical energy, inevitably generating excess activated oxygen species causing severe cell damage. Furthermore, atrazine fixes D1 protein, which is involved in photosynthesis, and as such inhibits same with a severe effect on the essential functions of the plant.

Some biological adaptation mechanisms enable plants to protect themselves against the damage caused by triazines. These include resistance induced by natural genetic mutation of the psb4 gene coding for D1 protein. This mutation prevents the atrazine fixation and as such improves the resistance of the plant to pollutants.

Atrazine resistance may also result from biochemical adaptation of the plant. In this way, sorghum may be “immunized” against atrazine by fighting free radicals via an increase in the Glutathione-S-transferase-related enzyme activity thereof.

Furthermore, transgenic plants incorporating a set of bacterial genes coding for atrazine degradation may grow using organic pollutants as a source of carbon and energy, inducing site decontamination.

In France, and in some other European countries, the use of open-field farming of these transgenic plants is particularly restricted especially due to the de facto moratorium on genetically modified organisms and significant reticence on the part of society.

Numerous techniques are known enabling the decontamination and restoration of polluted soils and sites such as excavation followed by off-site treatment, on-site heat treatment, soil washing, volatility processes, etc. In parallel with these physicochemical techniques, milder biological methods, such as phytoremediation, are developing for different types of pollutants, particularly of metallic or organic origin. These techniques consist of growing specific plants capable of resisting and fixing the pollutants to be treated in the tissue thereof.

In this way, the technique described in patent application WO2005/025769 consists of improving the efficiency of the phytoremediation technique through the addition of carbohydrates to the plants cultivated on the site to be decontaminated.

Moreover, it is known that adding polyamines to plants also improves the resistance of the plants for various types of natural environmental stress (thermal shock, osmotic stress, bacterial infections, etc) or stress associated with human activity (xenobiotic pollution).

Some physiological mechanisms involved have been elucidated such as nucleic acid stabilization, the induction of certain nucleic acid and protein syntheses, particularly during cell division, cell membrane stabilization and the increase in the permeability thereof to certain substances.

In any case, the efficiency of these methods remains subject to optimization particularly in relation to site remediation rates or in relation to residual limits of pollutants remaining on the site after treatment.

### AIMS OF THE INVENTION

The aim of the present invention is to propose an effective and easy-to-use method for improving the stress resistance of plants.

In particular, one of the aims of the present invention is that of offering such a method enabling increased efficiency of routine phytoremediation methods.

A further aim of the invention is that of providing a technically improved method which remains economically beneficial.

### DESCRIPTION OF THE INVENTION

These aims, along with others which will emerge hereinafter, are achieved by means of the invention which relates to a method for improving the resistance of a plant to at least one type of stress; said method is characterized in that it comprises at least one step consisting of cultivating at least one plant in the presence of at least one water-soluble exogenous carbohydrate suitable for assimilation by said plant and at least one polyamine family molecule or a substance containing said polyamine family molecule.

The method according to the invention may particularly be implemented to improve the resistance of plants to various types of environmental stress, of natural origin such as thermal stress, hydric stress, osmotic stress, or arising from human activity such as the presence of a metallic or organic pollutant.

According to this advantageous alternative embodiment, the method according to the invention originally proposes to grow plants on soils, in the presence of at least one carbohydrate, and at least one polyamine, thus stimulating the growth of the plants while reinforcing the stress resistance mechanisms. It is recommended to add these activators several times during treatment. According to the type of plant selected and the stress encountered, numerous carbohydrates suitable for assimilation by the plant may be used, alone or in a mixture, for the implementation of the invention. A mono-saccharide, a di-saccharide, a tri-saccharide, or a mixture thereof, or sugar industry residue may particularly be used.

According to one alternative embodiment of the invention, either glucose and/or sucrose will be used. According to one preferred alternative embodiment, the carbohydrate will be sucrose.

Similarly, according to the type of plant selected and the stress encountered, various polyamines may be added to the plant.

In this way, according to one alternative embodiment of the invention, the polyamine used will be of biological origin and will be selected from the group including putrescine, spermidine, spermine, cadaverine or a composition including at least one of these compounds and/or will be selected from the group consisting of diethylene triamine, triethylene tetramine, tetraethylene pentamine, tetrahydrofurfuryl amine, or a composition including at least one of these compounds.

According to one particularly preferred alternative embodiment, the polyamine of biological origin will be putrescine.

The quantities of sugars and polyamines supplied to the plant will vary according to numerous factors associated, among other things, with the type of soil, climatic conditions, the type of plant and the type of stress.

As an indication, a mixture comprising a molar ratio of 5 to 10 in carbohydrate(s) and polyamine(s) may be used.

As an indication, a carbohydrate concentration between 10 to 90 millimolar in the irrigation water and a polyamine concentration between 3 to 6 millimolar in the irrigation water will be used.

A plurality of means may be used to embody the invention.

According to one embodiment, the carbohydrate and the polyamine will be applied simultaneously to the plant, for example, by coating the seeds, or in liquid or solid form during the growth of the plant.

According to one embodiment, an active composition comprising at least one carbohydrate and at least one polyamine may be administered directly to the roots and/or foliage of the plants.

The invention also relates to any product for the implementation of such a method including a mixture of at least one exogenous carbohydrate and at least one polyamine.

According to one alternative embodiment of the invention, the active product will contain a carbohydrate selected from the group consisting of a mono-saccharide, a disaccharide, a tri-saccharide, particularly glucose or sucrose, or a composition including at least one of these compounds and a polyamine selected from the group consisting of putrescine, spermidine, spermine, cadaverine, diethylene triamine, triethylene tetramine, tetraethylene pentamine, tetrahydrofurfuryl amine, or a composition including at least one of these compounds.

According to one preferential alternative embodiment, the active product consists of a mixture of sucrose and putrescine.

According to one preferred alternative embodiment, the product will consist of at an aqueous or solid mixture having a molar ratio of 5 to 10 in (carbohydrates):(polyamines).

According to one advantageous alternative embodiment of the invention, said product is a seed coating product.

According to a further alternative embodiment, said product is a product to be diluted in a plant irrigation fluid.

### LIST OF FIGURES

The invention, and the various advantages represented by same, will emerge more clearly on reading the following description of a preferential embodiment, given for illustrative and non-limitative purposes, with reference to the figures wherein:

FIG. 1 shows photographs of seedlings cultivated in the presence of atrazine (1 μM), without any additive, in the presence of 3% sucrose and, according to the present invention, in the presence of 3% sucrose and 3 to 6 mM putrescine;

FIG. 2 shows in comparative terms the effect of the basic sucrose treatment and the effect of the invention of biomass growth (% fresh weight);

FIG. 3 describes in comparative terms the effect of the basic sucrose treatment and the effect of the invention on photosynthetic activity (μg chlorophyll produced/seedling);

FIG. 4 illustrates in comparative terms the effect of the basic sucrose treatment and the effect of the invention on main root development (cm);

FIG. 5 quantifies in comparative terms the effect of the basic sucrose treatment and the effect of the invention on plant root primordium development;

FIGS. 6 to 9 are photographs showing various phases of the cellular root primordium establishment process, the origin of the secondary root system.

### DESCRIPTION OF AN EMBODIMENT OF THE INVENTION

The inventors completed experiments demonstrating that adding polyamines and water-soluble exogenous carbohydrates to the culture medium of the Arabidopsis thaliana plant gave same an increased tolerance to atrazine even at high concentrations. In this context, a mixture of sucrose and putrescine were tested.

Thale cress (Arabidopsis thaliana, Wassilewskija ecotype) seeds were sterilized, rinsed with absolute ethanol, dried overnight and cultured in Petri dishes on a Murashige and Skoog agar (0.8%) culture medium (adjusted to pH 5.7), in the present of atrazine at a rate of a 1 μM molar concentration.

For a first control, no carbohydrate or polyamine were added to the culture medium.

For a second control, only sucrose, at a rate of 3%, which is equivalent to a concentration of 87 millimolar, was added thereto.

Finally, for a test according to the present invention, sucrose, at a rate of 3% and putrescine, at a rate of 3 to 6 mM, were added to the culture medium. The Petri dishes were stored for 48 hrs at 4° C. and transferred to 22° C. for a photoperiod of 16 hours per day at 4500 lux. The parameters characterizing the plant growth were referenced after 15 days of incubation: the biomass (% fresh weight) and chlorophyll (μg/seedling) produced were determined; the development of the main root (cm) and the secondary root system (primordia/seedlings) were recorded.

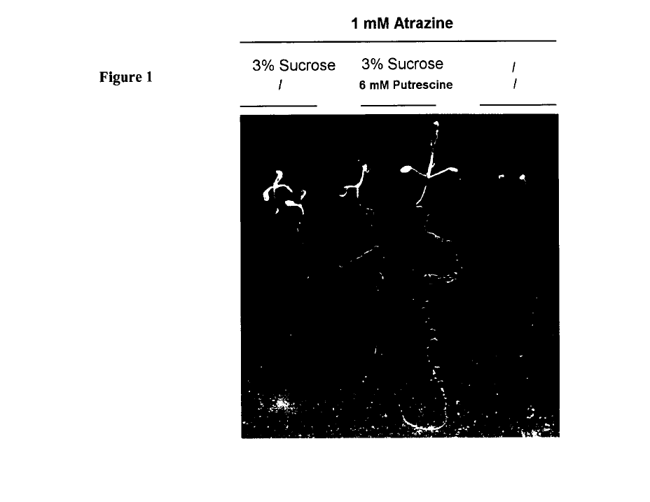

As can be seen in the right section of FIG. 1, in the presence of 1 μM of atrazine, the seedlings are unable to develop the photosynthetic apparatus, the development thereof stops after the impregnation of the seed and the initiation of germination per se.

The presence of a sugar (sucrose) substrate makes it possible to lift the atrazine inhibition effect, as demonstrated by the size of the seedlings in the left section of the same figure.

Finally, the use, according to the present invention, of sucrose and putrescine stimulates atrazine resistance and remediation spectacularly, as indicated by the size of the seedlings in the medium in FIG. 1.

FIG. 1, which compares the root development of the seedlings cultivated according to the invention and according to both controls, shows an improved stimulation of this root system by 75% with the treatment proposed by the present invention (3% sucrose and 2 to 6 mM putrescine), compared to the treatment consisting of merely adding 3% sucrose to the culture medium.

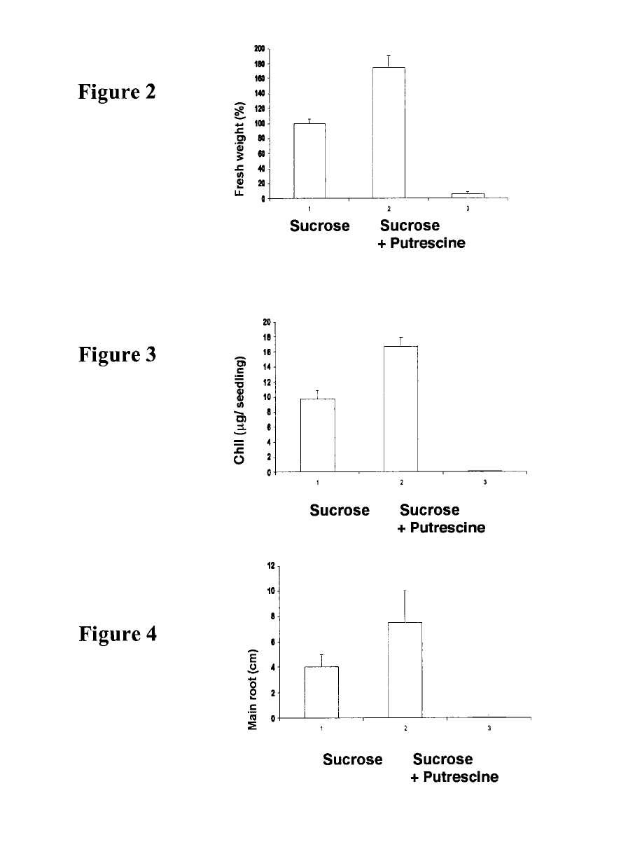

FIG. 2 displays a 75% increase in biomass development (% fresh weight) after a treatment according to the invention compared to the treatment only with the addition of sucrose.

FIG. 3 displays a 70% increase in potential photosynthetic activity (ug chlorophyll produced/seedling) after a treatment according to the invention compared to the treatment only with the addition of sucrose.

FIG. 4 displays a 100% improvement of the development of the main root (cm) of the seedlings after a treatment according to the invention compared to the treatment only with the addition of sucrose.

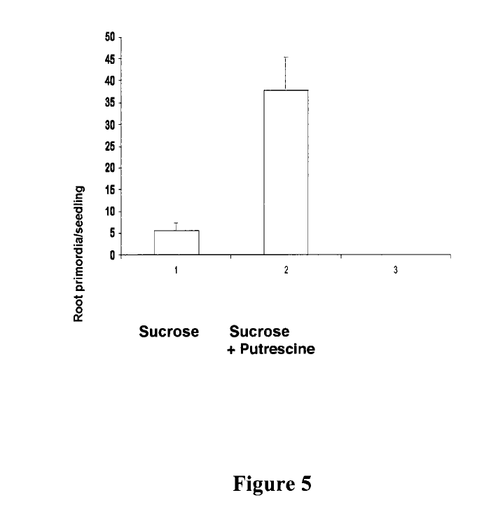

FIG. 5 displays that the number of root primordia and thus secondary roots increases by a factor of approximately 8 in seedlings after a treatment according to the invention compared to the treatment only with the addition of sucrose.

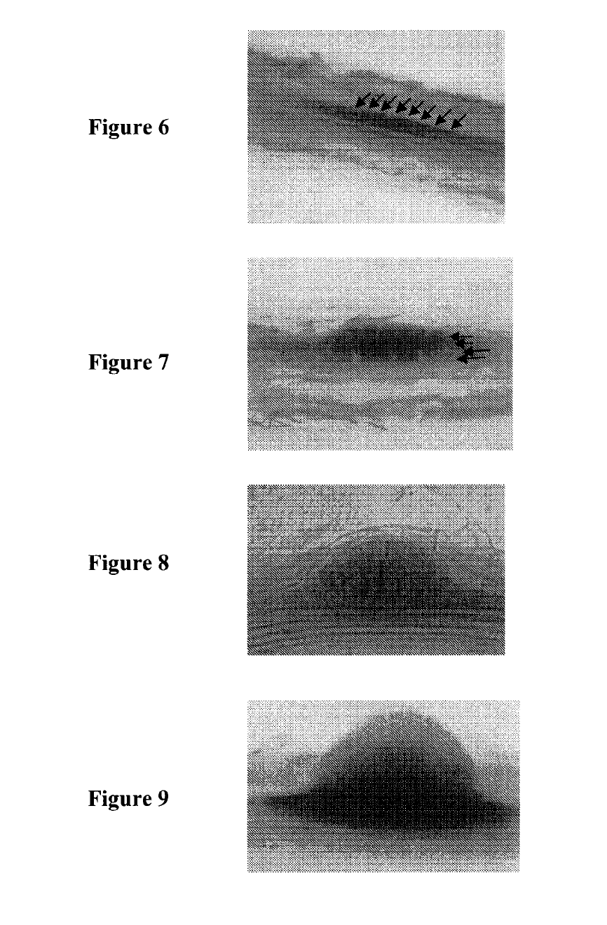

According to the root primordium establishment process, the pericycle cells firstly undergo a series of anticlinal divisions, perpendicular to the axis of the root, as indicated in FIG. 6. These cells then undergo periclinal divisions, parallel with the axis of the root, as indicated in FIG. 7, which makes it possible to increase the cell mass (see FIG. 8). Finally, the organ formed starts to take the form of a root and break through the tissues covering same to extend and form a functional root, as shown in FIG. 9.

1. Method for improving the resistance of a plant to at least one type of environmental stress, said method being characterized in that it comprises at least one step consisting of cultivating at least one plant in the presence of at least one water-soluble exogenous carbohydrate suitable for assimilation by said plant and at least one polyamine family molecule or a substance containing said polyamine family molecule, in a sufficient quantity to induce said resistance.

2. Method according to claim 1 characterized in that said stress is in the group consisting of abiotic stress, biotic stress, thermal stress, hydric stress, nutrient deficiency, osmotic stress, chemical stress induced by a metallic or organic pollutant in the soil whereon the plant is cultivated.

3. Method according to claim 1 characterized in that said environmental stress induces oxidative stress and/or inhibits photosynthesis.

4. Method according to claim 3 characterized in that said environmental stress is a herbicide.

5. Method according to claim 4 characterized in that said pollutant is a triazine.

6. Method according to claim 1 characterized in that said water-soluble exogenous polyamine is of biological origin.

7. Method according to claim 6 characterized in that said polyamine of biological origin is selected from the group consisting of putrescine, spermidine, spermine, cadaverine or a composition including at least one of these compounds.

8. Method according to claim 7 characterized in that said polyamine of biological origin is putrescine.

9. Method according to claim 1 characterized in that said water-soluble exogenous polyamine is selected from the group consisting of diethylene triamine, triethylene tetramine, tetraethylene pentamine, tetrahydrofurfuryl amine, or a composition including at least one of these compounds.

10. Method according to claim 1 characterized in that said water-soluble exogenous carbohydrate is a mono-saccharide, a disaccharide or a tri-saccharide.

11. Method according to claim 10 characterized in that said water-soluble exogenous carbohydrate is glucose or sucrose.

12. Method according to claim 1 characterized in that said carbohydrate and said polyamine are added to said plant according to a (carbohydrate):(polyamine) molar ratio of 5 to 10.

13. Method according to claim 1 characterized in that said carbohydrate is used as a rate of a concentration in irrigation water between 10 and 90 mM.

14. Method according to claim 1 characterized in that said polyamine is used at a rate of a concentration in irrigation water between 0.5 and 6 mM.

15. Method according to claim 1 characterized in that said carbohydrate and said polyamine is applied to said plant simultaneously.

16. Product for implementing the method according to claim 1 characterized in that it consists of a mixture of at least one exogenous carbohydrate and at least one polyamine.

17. Product according to claim 16 characterized in that said carbohydrate is selected from the group consisting of a mono-saccharide, a disaccharide, a tri-saccharide, particularly glucose or sucrose, or a composition including at least one of these compounds and said polyamine is selected from the group consisting of spermidine, spermine, cadaverine, diethylene triamine, triethylene tetramine, tetraethylene pentamine, tetrahydrofurfuryl amine, or a composition including at least one of these compounds.

18. Product according to claim 17 characterized in that said mixture comprises sucrose and putrescine.

19. Product according to claim 16 characterized in that the mixture consists of an aqueous mixture of said carbohydrate and said polyamine according to a (carbohydrate):(polyamine) molar ratio of 5 to 10.

20. Product according to claim 16 to characterized in that it is a seed coating product.

21. Product according to claim 16 characterized in that it is product to be diluted in a plant irrigation fluid.
